(19) United States
(12) Patent Application Publication
(10) Pub. No.: US 2006/0224710 A1
(43) Pub. Date: Oct. 5, 2006

(54) Hall monitor-method and apparatus for providing contact information and communications capability for an organization

(76) Inventor: Dana L. Price, Cary, NC (US)

Correspondence Address: IBM CORP. (RALEIGH SOFTWARE GROUP);c/o Rudolf O Siegesmund Gordon & Rees, LLP, 2100 Ross Avenue, Suite 2600, DALLAS, TX, 75201, US

(21) Appl. No.: 11/084,427

(22) Filed: Mar. 18, 2005

(51) Int. Cl. G06F 15/173

(52) U.S. Cl. 709/223

(57) ABSTRACT

The invention comprises a computer-implemented “hall monitor” system. The hall monitor includes a centralized database of employee presence data, and server software that allows users to update and access employee presence data over a network through a custom interface. The invention allows organizations to manage employees and members working from various locations who require updates as to their peers'current contact and location information at any given time.

### FIELD OF THE INVENTION

In general, the invention described below relates to an electrical apparatus and corresponding methods for performing calculation operations, wherein the apparatus and methods are uniquely designed for or utilized in the administration or management of an enterprise. More specifically, the invention comprises a system that allows members of an enterprise to exchange contact and location information through a common interface, thereby facilitating collaboration within the enterprise.

### BACKGROUND OF THE INVENTION

Modern business enterprises often provide flexible working arrangements for employees. For example, some employees may have more than one office, while others may have no designated office. Still other employees may work at home through a virtual office. Thus, such arrangements may give rise to occasions when an employee is difficult to locate, but nonetheless available for collaborating with other employees.

Instant messaging tools, such as IBM's LOTUS Instant Messaging & Web Conferencing software (formerly SAMETIME), MSN MESSENGER, or YAHOO! MESSENGER, also are common in modern business enterprises, and such tools usually include a means for users to detect each other's presence while online. In particular, instant messaging tools frequently provide an assortment of status indicators from which a user can select, such as “Available” or “Away.” Many even allow a user to create custom indicators. While a user is online, other subscribers of the same instant messaging service are able to view the user's status indicator.

Although instant messaging tools provide a means for detecting a user's presence online, the tools are inadequate to address many of the communications issues that face an enterprise with flexible working arrangements and highly mobile employees. In particular, instant messaging tools allow a user to detect another user only if the other user subscribes to the same service and runs the same instant messaging software, and only if the other user's instant messaging software has an active network connection. Thus, known instant messaging tools provide no useful status information if an employee is not running an instant messaging tool or is not active on the network. Moreover, known instant messaging tools do not provide sufficiently detailed status information, leaving many users to guess at the reasons for another user's absence or the anticipated length of the absence.

These and other objects of the invention will be apparent to those skilled in the art from the following detailed description of a preferred embodiment of the invention.

### SUMMARY OF THE INVENTION

The invention described below is a computer-implemented “hall monitor” system. The hall monitor includes a centralized database of employee “presence” data, and server software that allows users to update and access employee presence data over a network through a custom interface.

### BRIEF DESCRIPTION OF DRAWINGS

The novel features believed characteristic of the invention are set forth in the appended claims. The invention itself, however, as well as a preferred mode of use, further objectives and advantages thereof, will be understood best by reference to the following detailed description of an illustrative embodiment when read in conjunction with the accompanying drawings, wherein:

FIG. 1 represents an exemplary network of computers;

FIG. 2 is a schematic of a memory having the components of the present invention loaded therein;

FIG. 3 illustrates the contents of an exemplary database of the present invention;

FIG. 4 represents an exemplary interface of the present invention, as displayed in an exemplary client program;

FIG. 5 illustrates the interaction between software components of the present invention;

FIG. 6 illustrates the operation of the present invention's administration module;

FIG. 7 represents an exemplary message interface of the present invention; and

FIG. 8 represents an exemplary message archive interface of the present invention.

### DETAILED DESCRIPTION OF THE PREFERRED EMBODIMENT

The principles of the present invention are applicable to a variety of computer hardware and software configurations. The term “computer hardware” or “hardware,” as used herein, refers to any machine or apparatus that is capable of accepting, performing logic operations on, storing, or displaying data, and includes without limitation processors and memory; the term “computer software” or “software,” refers to any set of instructions operable to cause computer hardware to perform an operation. A “computer,” as that term is used herein, includes without limitation any useful combination of hardware and software, and a “computer program” or “program” includes without limitation any software operable to cause computer hardware to accept, perform logic operations on, store, or display data. A computer program may, and often is, comprised of a plurality of smaller programming units, including without limitation subroutines, modules, functions, methods, and procedures. Thus, the functions of the present invention may be distributed among a plurality of computers and computer programs. The invention is described best, though, as a single computer program that configures and enables one or more general-purpose computers to implement the novel aspects of the invention. For illustrative purposes, the inventive computer program will be referred to as the “hall monitor” program.

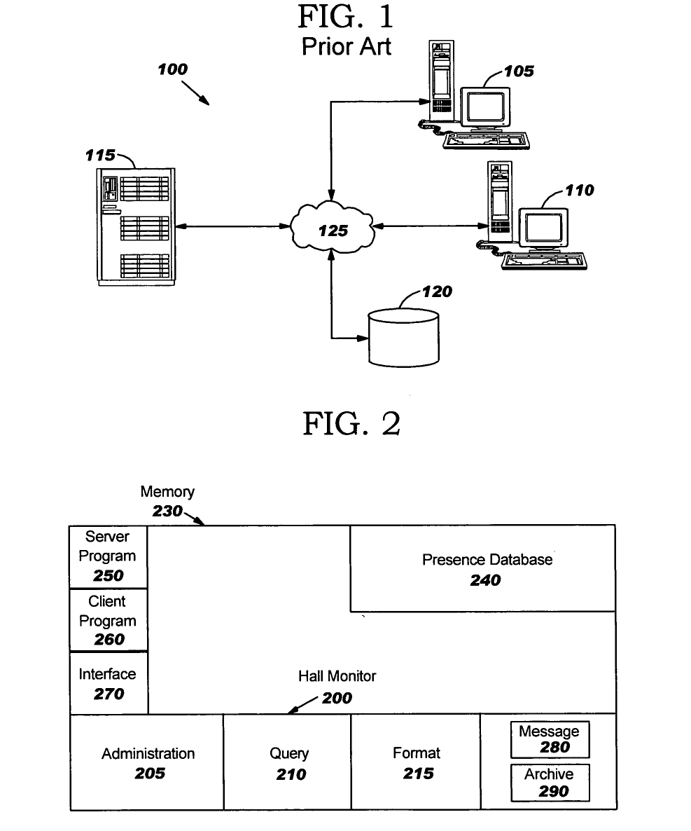

Additionally, the hall monitor program is described below with reference to an exemplary network of hardware devices, as depicted in FIG. 1. A “network” comprises any number of hardware devices coupled to and in communication with each other through a communications medium, such as the Internet. A “communications medium” includes without limitation any physical, optical, electromagnetic, or other medium through which hardware or software can transmit data. For descriptive purposes, exemplary network 100 has only a limited number of nodes, including workstation computer 105, workstation computer 110, server computer 115, and persistent storage 120. Network connection 125 comprises all hardware, software, and communications media necessary to enable communication between network nodes 105-120. Unless otherwise indicated in context below, all network nodes use publicly available protocols or messaging services to communicate with each other through network connection 125.

The hall monitor program has been developed to facilitate group collaboration in a corporate environment, but may just as easily facilitate collaborative efforts in any community or organization. Likewise, the hall monitor program has been developed using Perl scripts that use the Common Gateway Interface (CGI) to deliver data over a network to a browser using the HyperText Transfer Protocol (HTTP), but the principles embodied in the hall monitor program are applicable to any language that can leverage network protocols and interfaces to serve data to a client over a network. Hall monitor 200, which includes administration module 205, query module 210, and format module 215, typically is stored in a memory, represented schematically as memory 230 in FIG. 2. The term “memory,” as used herein, includes without limitation any volatile or persistent medium, such as an electrical circuit, magnetic disk, or optical disk, in which a computer can store data or software for any duration. A single memory may encompass and be distributed across a plurality of media. Thus, FIG. 2 is included merely as a descriptive expedient and does not necessarily reflect any particular physical embodiment of memory 230. As depicted in FIG. 2, though, memory 230 may include additional data and programs. Of particular import to hall monitor 200, memory 230 includes presence database 240, server program 250, and client program 260 with which hall monitor 200 interacts. Server program 250 represents any program that receives and responds to data requests from remote clients over a network, such as network 100. Preferably, though, server program 250 is a web server program, which receives and responds to HTTP requests with data formatted as hypertext markup language (HTML). Likewise, client program 260 represents any program that sends data requests to and processes responses from a remote server program, including server program 250, over a network, such as network 100. Preferably, though, client program 260 is a web browser program, such as MOZILLA's FIREFOX or MICROSOFT's INTERNET EXPLORER, that uses HTTP to send requests and receive HTML responses. Hall monitor 200 also interacts with interface module 270, which may be integrated into hall monitor 200 or server program 250, or may be an independent software component. As those skilled in the art should appreciate, interface module 270 is a necessary component in the preferred system because conventional web server programs respond to requests with only static data. Interface module 270 allows a web server program to interact and exchange data with external programs, such as hall monitor 200. In the preferred embodiment, interface module 270 is a commonly used component known as the Common Gateway Interface (CGI), which frequently is integrated into a web server program. Other examples of interface modules that could be substituted for CGI include, but are not limited to, PHP processors, JAVASCRIPT engines, and JAVA SERVER PAGES (JSP).

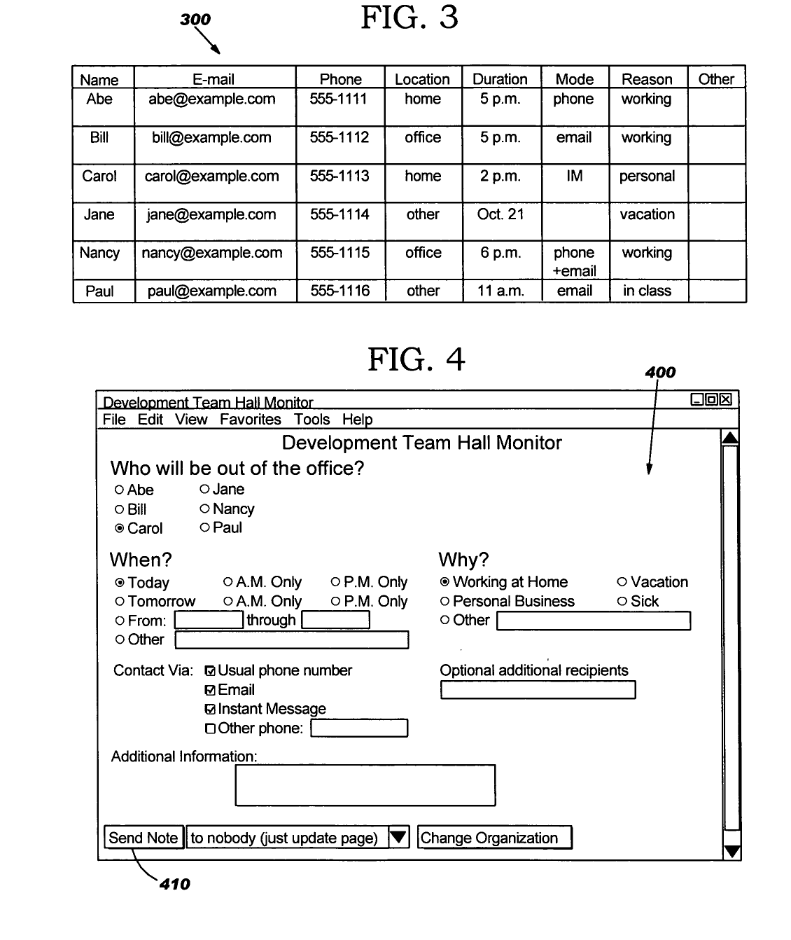

Presence database 240 represents any collection of information having the data fields described in detail below, regardless of any particular arrangement of data fields within the collection, including without limitation a relational database or a flat file database. In the preferred embodiment, presence database 240 is stored in persistent storage, such as persistent storage 120. In general, presence database 240 includes the names of all members in a group, each member's status, each member's electronic mail address, and each member's primary telephone number. Each member's status comprises at least four distinct fields, which indicate the member's location (e.g., in or out of the office), the duration of the member's presence in that location, at least one preferred mode of contacting the member, and the general reason for being in that location. Presence database 240 also may include other descriptive information about each member, such as a description of each member's affiliation with the group. The preferred contact mode represents a member's recommendation to users needing to contact the member. Examples of contact modes include calling the member at the member's primary telephone number, sending a message to the member's electronic mail address, and sending a message to the member via the member's instant messaging service. FIG. 3 illustrates the contents of an embodiment of presence database 240 for exemplary group 300. For the sake of clarity and brevity, exemplary group 300 represented in FIG. 3 consists only of six members (Abe, Bill, Carol, Jane, Nancy, & Paul).

FIG. 4 represents exemplary interface 400 of hall monitor 200, as displayed in an embodiment of client program 260. As described in detail below, query module 210 and format module 215 dynamically generate interface 400 when client program 260 sends a request for the interface to server program 250. In practice, of course, groups are likely to have many more members, and interface 400 would be rendered accordingly so that the name and status of all members are displayed in interface 400.

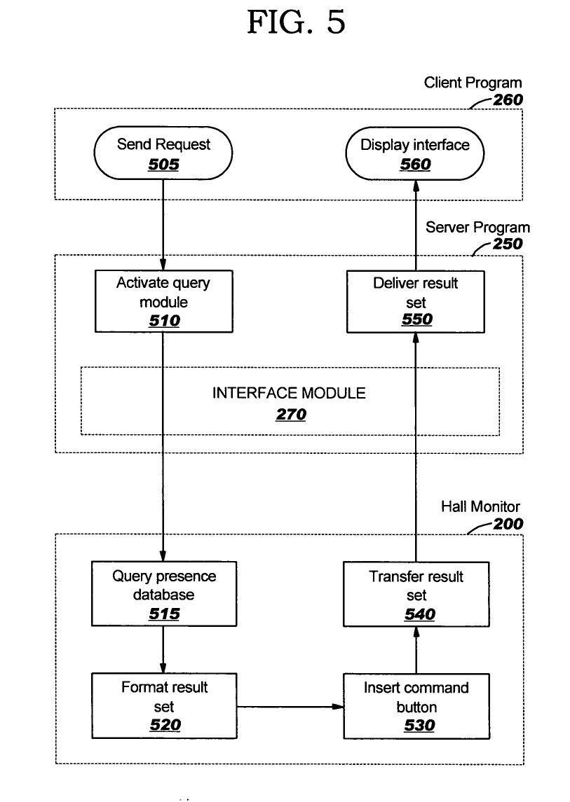

FIG. 5 illustrates the interaction between client program 260, server program 250, and hall monitor 200. When client program 260 sends a request for interface 400 to server program 250 (505), interface module 270 activates query module 210 (510). Query module 210 then queries presence database 240 to retrieve the names of all members identified in presence database 240, each member's status, each member's electronic mail address, and each member's primary telephone number, along with any other available descriptive information (515). The method of querying presence database 240 will vary according to the type and location of presence database 240, but such methods are well known and need not be described in detail here. For example, if presence database 240 is a relational database, it will likely be managed by a database management system (DBMS) that can process queries based on standardized languages such as the ubiquitous Structured Query Language (SQL). Alternatively, if presence database 240 is a flat file database, then query module 210 likely must parse the file to extract the desired data. Regardless of the query method, though, the collective data retrieved from presence database 240 is referred to herein as the “result set.”

Once query module 210 retrieves the result set from presence database 240, format module 215 formats the result set with appropriate tags and adds appropriate headings (520). In the simplest embodiment of the invention, the tags comprise standardized HTML tags, well-known to those of ordinary skill in the art, but the tags also may be adapted to conform to any structured markup language, such as the increasingly popular Extensible Markup Language (XML). Format module 215 also inserts a command button (530), such as command button 410 in FIG. 4, that allows a system user to activate administration module 205, which is described below. After format module 215 formats the result set (520), interface module 270 transfers the formatted result set to server program 250 (540), which in turn delivers the formatted result set to client program 260 (550). Client program 260 then displays the formatted result set in a window as interface 400 (560) (see, e.g., FIG. 4). Optionally, format module 215 also may use color codes, icons, and mouse-over text to enhance the format of the result set. Mouse-over text includes messages that client program 260 displays in pop-up windows or in a designated message area.

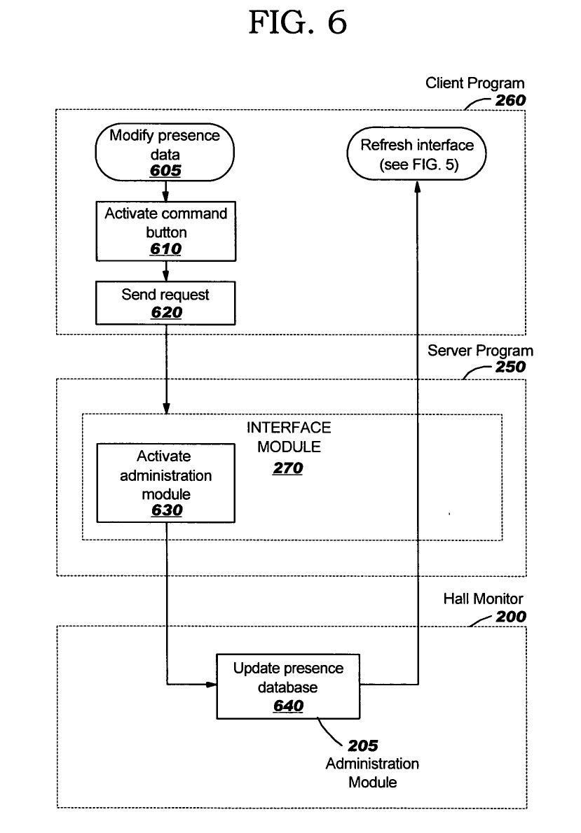

FIG. 6 illustrates the operation of administration module 205. To activate administration module 205, a user first updates or otherwise modifies the presence data displayed in interface 400 (605) and activates command button 410 (see FIG. 4) in interface 400 (610). In the preferred embodiment, server program 250 uses cookies to maintain frequently used data and to avoid repetitive data entry in interface 400. When the user activates command button 410, client program 260 sends a request to server program 250 that includes the modified presence data (620). Interface module 270 then activates administration module 205 (630), which updates presence database 240 (640). The methods of updating presence database 240 again will vary according to the type and location of presence database 240, but such methods are well known in the art and need not be described in detail here. Finally, client program 260 requests interface 400, and the process described above (see steps 505 through 560) is repeated to refresh the display.

In additional embodiments, hall monitor 200 supports multiple groups within an enterprise. To support multiple groups, hall monitor 200 either maintains a separate presence database for each group, or adds an additional data field to the presence database that identifies the group to which a given member belongs. Moreover, hall monitor 200 provides a separate interface 400 for each such group.

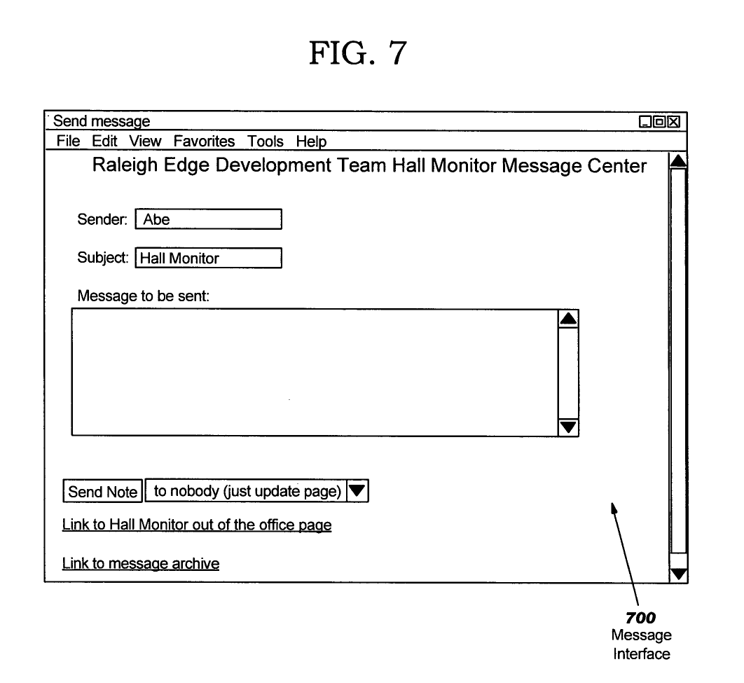

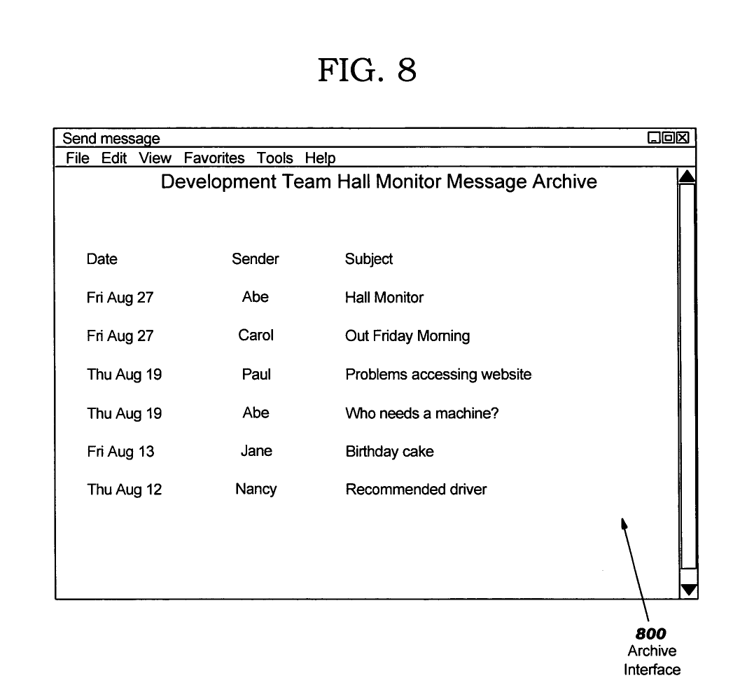

Hall monitor 200 additionally may include message module 280 (see FIG. 2), which allows users to send and archive messages to any or all members of the group. FIG. 7 represents exemplary message interface 700, which message module 280 generates dynamically when client program 260 sends a request for the interface to server program 250. One significant advantage of message module 280 over other communication modes is that it allows hall monitor 200 to maintain an archive of all messages exchanged between group members. A user can access the message archive through archive interface 800, which is generated dynamically by archive module 290 (see FIG. 2). An example of archive interface 800 is provided in FIG. 8. Like message module 280, archive module 290 dynamically generates archive interface 800 when client program 260 sends a request for the interface to server program 250.

A preferred form of the invention has been shown in the drawings and described above, but variations in the preferred form will be apparent to those skilled in the art. The preceding description is for illustration purposes only, and the invention should not be construed as limited to the specific form shown and described. The scope of the invention should be limited only by the language of the following claims.

What is claimed is:

1. A hall monitor system for displaying presence data in a client program over a network, the system comprising:
a database that identifies system users, a status for each system user, and at least one mode for contacting each system user;
a query program operative to query the database over a network connection and retrieve a result set from the database, the result set comprising the system users, the status of each system user, and each mode for contacting each system user;
an administrative program operative over the network to modify the system users identified in the database, modify the status of each system user identified in the database, and modify each mode for contacting each system user identified in the database;
a format program operative to mark the result set with markup language tags and to insert a command button into the result set that activates the administrative program; and
an interface program operative to transfer the marked result set and command button over the network to the client program.

2. The system of claim 1 wherein the network connection uses a hypertext transfer protocol.

3. The system of claim 2 wherein the markup language tags are hypertext markup language tags.

4. The system of claim 2 wherein the markup language tags are extensible markup language tags.

5. The system of claim 1 further comprising a message module operable to send a message to one or more system users.

6. The system of claim 5 wherein the message module further is operable to store the message in an archive.

7. A method of providing an graphical user interface to a computer-implemented hall monitor system having a display and a selection device, the method comprising:
querying a database over a network connection to retrieve a result set from the database, the result set comprising a set of system users, the status of each system user, and each mode for contacting each system user;
marking the result set with markup language tags;
inserting a modify command button into the result set;
drawing the result set with the modify command button on the display;
receving a modify signal indicating the activation of the modify command button and the modification of the result set; and
responsive to receiving the signal, modifying the database over the network connection so that the system users, the status of each system user, and each mode for contacting each system user conforms to the modifications of the result set.

8. The method of claim 7 wherein the network connection uses a hypertext transfer protocol.

9. The method of claim 8 wherein the markup language tags are hypertext markup language tags.

10. The method of claim 8 wherein the markup language tags are extensible markup language tags.

11. The method of claim 7 further comprising:
inserting a send command button into the result set;
receiving a send signal indicating the selection of one or more system users from the result set and the activation of the send command button;
responsive to receiving the send signal, sending a message to the selected system users.

12. The method of claim 11 further comprising storing the message in an archive.

13. A hall monitor system for displaying presence data in a client program over a network, the system comprising:
a database means for identifying system users, a status for each system user, and at least one mode for contacting each system user;
a query means for retrieve a result set from the database over a network connection, the result set comprising the system users, the status of each system user, and each mode for contacting each system user;
an administrative means for modifying the system users, modifying the status of each system user, and modifying each mode for contacting each system user;
a format means for marking the result set with markup language tags and inserting a modify command button into the result set operable to activate the administrative means; and
an interface means for transferring the marked result set and modify command button over the network to the client program.

14. The system of claim 13 wherein the network connection uses a hypertext transfer protocol.

15. The system of claim 14 wherein the markup language tags are hypertext markup language tags.

16. The system of claim 14 wherein the markup language tags are extensible markup language tags.

17. The system of claim 13 further comprising a message means for sending a message to one or more system users.

18. The system of claim 17 further comprising means for storing the message in an archive.
